(19) United States
(12) Patent Application Publication
(10) Pub. No.: US 2025/0242754 A1
(43) Pub. Date: Jul. 31, 2025

(54) METHOD FOR MONITORING A TAILLIGHT, MONITORING SYSTEM AND VEHICLE

(71) Applicant: ZF CV Systems Global GmbH, Bern (CH)

(72) Inventors: Jan-Christoph von der Beeke, Algermissen (DE); Tobias Klinger, Springe (DE)

(21) Appl. No.: 19/184,641

(22) Filed: Apr. 21, 2025

Related U.S. Application Data
(63) Continuation of application No. PCT/EP2023/076357, filed on Sep. 25, 2023.

(30) Foreign Application Priority Data
Oct. 21, 2022 (DE) 10 2022 127 889.1

(51) Int. Cl. B60Q 11/00; G01J 1/16; G01J 1/18

(52) U.S. Cl. CPC B60Q 11/005; G01J 1/18; B60Q 2800/20; G01J 2001/1673

(57) ABSTRACT

A method is for monitoring a taillight of a vehicle having a camera directed to the rear, wherein the taillight includes a light unit. The taillight and/or light surroundings illuminated by the taillight is/are captured by the at least one camera and camera signals are output. A camera image having pixels is provided depending on the output camera signals. The taillight of the vehicle or the light surroundings is represented in light pixels of the respective camera image. Brightness values are ascertained and evaluated at least for the light pixels of the camera image. A functional status of the taillight is ascertained depending on the ascertained brightness values and output.

### CROSS-REFERENCE TO RELATED APPLICATIONS

This application is a continuation application of international patent application PCT/EP2023/076357, filed Sep. 25, 2023, designating the United States and claiming priority from German application 10 2022 127 889.1, filed Oct. 21, 2022, and the entire content of both applications is incorporated herein by reference.

### TECHNICAL FIELD

The disclosure relates to a method for monitoring a taillight of a vehicle, in particular a utility vehicle, using a camera system, a monitoring system, and a vehicle having a monitoring system.

### BACKGROUND

Functional and visible taillights on vehicles are an essential safety aspect for road traffic and are therefore subject to a large number of legal provisions. Thus, for example, the German Road Traffic Licensing Regulations (StVZO) regulates which taillights are permitted to be attached to a motor vehicle or utility vehicle and which taillights have to be attached at least. Examples of taillights are rear lights, brake lights, turn signals, reflectors, rear fog lights, rear headlights, and a license plate lamp.

Light monitoring functions for such taillights are known from the prior art, which are based on the measured power consumption or on the monitoring of the supply line, in particular monitoring of the line interruption (incandescent wire blown) of the individual incandescent bulbs or LEDs of the taillights.

In utility vehicles, in particular trailers, the lights are monitored by a trailer light control unit on the motor vehicle or tractor vehicle, so that the monitoring in the trailer is dependent on whether and to what extent the motor vehicle carries out a light monitoring function.

A self-test of taillights, for example, via integrated photodiodes in addition to the individual incandescent bulbs/LEDs of the respective light units of the taillight, also results in problems since, for example, an external covering, for example, due to dirt or snow covering of the entire taillight cannot be reliably recognized and taillights additionally have to report a recognized fault to a control unit, thus have to be able to communicate, which is in turn complex and costly.

Ultimately however, the actual goal is not achieved by the light monitoring functions described in the prior art, namely ensuring that the taillights are visible or recognizable for the following traffic when they light up, thus actually function. For example, the brake light may not be visible due to a snow-covered taillight, although the tail-light as such functions and accordingly also cannot be recognized as faulty by the line monitoring function.

### SUMMARY

It is an object of the disclosure to specify a method for monitoring taillights of a vehicle using which the functionality of the taillights can be monitored easily and reliably. Furthermore, it is a further object of the disclosure to specify a monitoring system and a vehicle, using which the method can be carried out.

This object is achieved by a method, a monitoring system, and a vehicle according to various embodiments of the disclosure.

A method according to the disclosure for monitoring a taillight of a vehicle using a camera system, in particular as a component of a reversing assistance function, wherein the camera system includes a camera directed to the rear. The camera can therefore be oriented onto a rear space behind the vehicle or behind the respective vehicle part on which the camera is located. The taillight includes a light unit. The method includes the following steps:
the taillight of the vehicle and/or light surroundings illuminated by the taillight is captured by the camera on the vehicle and camera signals are output;
a camera image having pixels is displayed depending on the output camera signals, wherein the taillight of the vehicle and/or light surroundings illuminated by the taillight is or are displayed in light pixels of the respective camera image. The pixels of the camera image in which the taillight and/or the light surroundings is or are displayed are thus referred to as the light pixels;
brightness values are ascertained and captured at least for the light pixels of the respective camera image. This can mean that at least for the light pixels or some of the light pixels, a respective value characterizing the brightness is ascertained and processed;
a functional status of the taillight is ascertained and output depending on the ascertained brightness values or at least depending on the brightness values which are assigned to the respective displayed taillight in the respective camera image. The functional status can be output, for example, on a user interface in the form of a graphic and/or acoustic signal.

It is possible here that the camera system includes more than one camera and also that the camera system includes more than one camera directed to the rear. It is also possible that the vehicle includes more than one taillight. Multiple taillights or all taillights of the vehicle can be captured here by the same camera or by different cameras. The method can therefore be carried out via one camera or multiple cameras on one taillight or multiple taillights simultaneously or using multiple cameras in parallel for one or more taillights.

It can be provided here that before one of the mentioned steps for monitoring the taillights, that is, at least before ascertaining and outputting a functional status of the at least one taillight depending on the ascertained brightness values, it is initially checked whether the at least one taillight is activated. For this purpose, an activation signal transmitted via a CAN bus can be evaluated, which transmits information as to whether the respective taillight is activated or not. The method is thus only carried out when the respective taillight to be monitored is also switched on or activated, by which effort and computing power can be saved and the output of the functional status is restricted to the relevant period of time.

Furthermore, a monitoring system and a vehicle having such a monitoring system are provided according to the disclosure.

It is therefore recognized automatically or in an automated manner using the monitoring system whether the taillights of the vehicle are functional or visible and therefore also can be perceived by the following traffic. The lights can either be depicted directly here or the light surroundings, which are irradiated by the lights upon their activation, for example, the roadway, buildings, the ego vehicle, other vehicles, et cetera. The functional status of the taillights thus includes not only the technical functionality of the taillights, which can be impaired, for example, in the event of a defective supply line and/or a defective LED, but rather also an actual perceptibility, thus whether the taillights can also meet their function of warning and/or increasing the visibility for other road users.

In particular, the disadvantage of conventional light monitoring is overcome, according to which covered taillights, that is, for example, soiled or snowed over, are recognized as functional, but are just no longer (completely) visible or perceptible for the other road users, so that they can no longer meet their actual intended function. This is performed by the direct observation of the taillights or by the observation of the light surroundings.

A further advantage is that the camera which assists the driver as a component of a reversing assistant when maneuvering is additionally used for monitoring the taillights. This camera can therefore fulfil a double function. Such cameras, in particular reversing cameras, are already very widespread and will also be legally required in future in utility vehicles, for example, so that they are then already present in any case. No additional hardware is therefore required, but rather an already present camera is used.

By way of the method according to the disclosure for light monitoring, operating sequences, such as the departure check, in which a function check of the taillights takes place, can therefore be simplified/automated and accelerated. In addition, it increases the level of safety of vehicles, in particular of autonomously operated vehicles, which manage without a driver controlling the vehicle and/or monitoring the journey.

The evaluation of the brightness values or the ascertainment of the functional status of the at least one taillight is carried out according to an embodiment of the method in that a histogram and/or a pattern representation (in a higher-dimensional feature space) is created from the provided camera image, wherein a distribution of the brightness values at least of the light pixels of the respective camera image is represented in the histogram and/or in the feature representation. In this way, a brightness distribution characteristic for the current situation can be used to ascertain the functionality of the taillights. If a pattern representation is used, accordingly not only brightness values, but also, for example, color values, saturations, and contrasts are available as further features for evaluation, for example, by tools of machine learning.

According to an embodiment, it can be provided here that to ascertain the functional status of the at least one taillight, the histogram created from the camera image is compared to a reference histogram, wherein the reference histogram is created from a reference camera image. Alternatively or cumulatively, it can be provided that to ascertain the functional status of the at least one taillight, the pattern representation created from the camera image is compared to a reference pattern representation, wherein the reference pattern representation is created from the reference camera image. Such a comparison thus includes a comparison of historic, previously recorded (reference) camera images to a current camera image or to the brightness distributions following therefrom.

On the one hand, it can be provided here that fully functional taillights of the vehicle and/or the light surroundings irradiated by the fully functional taillights of the vehicle is or are displayed in the reference camera image. The functionality is thus checked in a simple manner as to whether the brightness distribution at the point in time of the recording of the camera image corresponds to a brightness distribution with functioning taillights. If, for example, the light pixels in the reference camera images are displayed brighter, that is, with a higher intensity, in the switched-on state than in the current camera image in the switched-on state of the taillights, it can thus be concluded easily that the currently recorded taillight is defective or covered, for example, soiled or covered with snow, and it is possible to react accordingly.

It can then be ascertained and output as the functional status that the or a taillight is defective or covered if the histogram created from the camera image deviates from the reference histogram and/or the pattern representation created from the camera image deviates from the reference pattern representation. Easy and reliable ascertainment and output of the functionality is enabled in this way.

On the other hand, however, it can be provided that deactivated taillights of the vehicle and/or the light surroundings with deactivated taillights of the vehicle is or are displayed in the reference camera image. The functionality is thus checked in a simple manner as to whether the brightness distribution at the point in time of the recording of the camera image (with activated taillights) differs from a brightness distribution with deactivated taillights (reference camera image), which is to be assumed, since the recorded brightness is supposed to change It can then be ascertained and output as the functional status that the or a taillight is defective or covered if the histogram created from the camera image corresponds to the reference histogram and/or the pattern representation created from the camera image corresponds to the reference pattern representation, since the brightness has not changed in this case. Easy and reliable ascertainment and output of the functionality is also enabled in this way.

According to a further embodiment, it is provided that the histogram is subjected to a brightness adaptation before the comparison to the reference histogram and/or the pattern representation is subjected to a brightness adaptation before the comparison to the reference pattern representation, wherein the brightness values displayed in the histogram or the pattern representation are adapted for this purpose depending on a current ambient brightness. It is thus taken into consideration that the ambient brightness can vary greatly, for example, because of the time of day or because of the surroundings, which also has effects on the histogram and/or the pattern representation or the brightness values depicted therein. In order that this effect can be taken into consideration, the ambient brightness is calculated out or the histogram and/or the pattern representation is accordingly scaled in the brightness in order to provide a histogram or a pattern representation for comparison with the reference independently of the ambient brightness. The ambient brightness can be ascertained, for example, by averaging of the brightness values of all pixels of the camera image or of the brightness values of all pixels except for the light pixels.

According to a further embodiment, it can be provided that to ascertain the functional status of the taillight, it is ascertained whether the brightness values of the histogram and/or the pattern representation are in a desired brightness range assigned to the respective taillight. Multiple desired brightness ranges can be assigned to each taillight. It can thus be checked whether specific brightness values are captured in the histogram and/or in the pattern representation for the respective taillight, wherein this can be, for example, dependent on the color of the taillight or the light units contained therein. A desired brightness range can thus be assigned to each light unit of the respective taillight, which can then be read off in a light-specific manner from the histogram and/or the pattern representation.

It can also be provided here that it is additionally ascertained whether at least one defined desired pixel proportion of brightness values is in the desired brightness range assigned to the respective taillight. It is thus not only checked whether a specific brightness value occurs in the histogram and/or in the pattern representation, but also the frequency of the brightness values which are within the brightness range. In this way, a statement about the degree of the functionality, for example, partially defective or partially covered, is also possible.

It can then be ascertained and output as a functional status that the or a taillight is defective or covered, for example, if the brightness values of the histogram and/or pattern representation created from the camera image are not within the assigned desired brightness range or are not within the defined desired pixel proportion within the at least one assigned desired brightness range. In this way, a simple check and output of the functionality of the taillights is provided.

The light monitoring is furthermore improved or made more stable according to a further embodiment of the method by a calibration step, wherein the number of pixels which are used for the evaluation of the brightness values is further restricted by this step. This can take place, for example, in that the ascertainment and evaluation of brightness values is only carried out for static pixels of the provided camera image, wherein the light pixels are contained as a subset in the static pixels.

During a journey of the vehicle, all nonstatic, thus dynamic pixels change, which represent the then progressively changing surroundings around the vehicle. By detecting these dynamic pixels, the static pixels in the camera image can be clearly ascertained in reverse, which in turn represent camera-fixed and therefore vehicle-fixed objects. By recognizing the static pixels, the area in which the taillights are located in the camera image can initially be delimited, since the taillights are connected fixed in place to the vehicle and the light pixels are therefore a component or a subset of these static pixels. The contours of the vehicle visible in the camera image, including the taillights, can thus be identified (beforehand) during a journey of the vehicle by this moving image comparison or this distinction between dynamic and static pixels.

The identification of the taillights in the camera image can be refined still further with the aid of a histogram, so that it is possible that the ascertainment and evaluation of brightness values is carried out only for the light pixels of the provided camera image, wherein the light pixels are identified in that the brightness values of the pixels, in particular only the static pixels, of the provided camera image are evaluated over time during an activation and a subsequent deactivation of the respective taillight, wherein the pixels, the brightness values of which change over time due to the activation and the subsequent deactivation of the respective taillight, are identified as light pixels.

For more accurate delimitation of the position of the taillights in the camera image, a controlled activation and deactivation of the taillights with observation of the brightness values can thus take place in an initial calibration in the fully functional state. The light pixels in the camera image can thus be found in an easier and more reliable manner and the following evaluation of the brightness values in operation of the vehicle can be restricted to these light pixels, which reduces the evaluation effort and makes the recognition more stable, since no “background” due to brightness values which are not assigned to the taillights is contained in the histogram or this “background” can be minimized.

In a further embodiment of the method, the light monitoring is carried out for a motor vehicle taillight on a motor vehicle of the vehicle and/or for a trailer taillight on a trailer of the vehicle, wherein the respective taillight includes at least one light unit, which is selected from a group including: reflector, brake light, rear light, rear fog light, license plate lamp, turn signal, outline light.

In this way, the ascertainment and output of the functional status of the taillight or taillights can take place individually and possibly also singly for each light unit, so that individual taillights or light units can be deliberately replaced, repaired, and/or cleaned. The method is therefore also not only restricted to a specific vehicle type.

In a further embodiment of the method, a heating element on the respective taillight and/or a cleaning system of the respective taillight is actuated depending on the ascertained and evaluated brightness values at least for the light pixels of the respective camera image and/or depending on the ascertained and output functional status of the at least one taillight.

Novel LED lights can have heating elements here in order to thaw snow covers and thus ensure the visibility of the lights in case of snowfall. It is advantageous to switch on these heating elements only as needed in order to save energy, which can advantageously take place in the present case in accordance with the previously ascertained functional status. The camera or the taillights can be freed of dirt and/or snow by a cleaning system, in particular for the camera or for the taillights, for example, a wiper or a spraying device. If the functional status thus initially indicates that a defective or covered taillight is present, an attempt can initially be made by cleaning to produce a reliable camera image again or enable lighting of the taillights.

The method can then be carried out again after a completed actuation of the heating element and/or the cleaning system and a functional status can be checked again in order to then indicate an ultimate defect. This prevents an incorrect functional status of the taillights from being output due to a covering (dirt/snow) of the taillights or the camera.

In an embodiment of the monitoring system, it is provided that the at least one camera directed to the rear has a detection range having an opening angle of ≥180°, in particular is a fisheye camera, so that the camera can directly capture the at least one taillight and the light surroundings. In this way, it is possible to capture the taillights using only one camera on a rear side of the respective vehicle or vehicle part. Such cameras can also be used efficiently in a reversing assistant, since they capture a large part of the rear space behind the vehicle or the relevant vehicle part. The taillights of the vehicle are then normally also located in this capture area. However, it can also be provided that the camera can only capture the light surroundings, for example, if a fisheye camera is not yet used or the visible area is concealed. In this case, the light monitoring can also be carried out as described by capturing only the light surroundings.

### BRIEF DESCRIPTION OF DRAWINGS

The invention will now be described with reference to the drawings wherein:

FIG. 1 shows a schematic top view of a vehicle having a camera system;

FIG. 2 shows a histogram having a distribution of brightness values of a taillight captured via the camera system;

FIG. 3A shows a camera image of a camera of the camera system;

FIG. 3B shows a camera image of the camera, wherein only the dynamic pixels are shown;

FIG. 3C shows a camera image of the camera, wherein only the static pixels are shown; and,

FIG. 4 shows a flow chart of the method according to the disclosure.

### DETAILED DESCRIPTION

FIG. 1 shows a schematic top view of a trailer 2b or semi-trailer as part of a vehicle 1, which moreover also includes a motor vehicle 2a as a tractor vehicle as indicated. The vehicle 1 includes a camera system 4 having cameras 8, in particular having a trailer camera 8b, which is directed to the rear and is arranged on the trailer 2b, and which can be a component of a reversing assistant 3, for example, and a control unit 6. The control unit 6 can also be arranged in the motor vehicle 2a.

The trailer camera 8b is provided with a fisheye lens, that is, it is embodied as a fisheye camera 9, and therefore has a capture area E having an opening angle of ≥180°. The motor vehicle 2a can also include, as a component of the camera system 6, a motor vehicle camera 8a directed to the rear, which is embodied as a fisheye camera 9 and can be a component of the reversing assistant 3. In this way, the motor vehicle 2a can be moved toward the trailer 2b in an assisted manner, for example, during a coupling procedure.

The control unit 6 is configured to carry out a method for monitoring a taillight 5 of the vehicle 1, in particular of trailer taillights 5b on the trailer 2b, wherein each trailer taillight 5b consists in the illustrated embodiment of three light units 7a, 7b, 7c in each case, which upon activation of the respective taillight 5 emit light into light surroundings U5, in particular onto an underlying surface, onto a building, the ego vehicle 1, onto other vehicles, et cetera. However, motor vehicle taillights 5a on the motor vehicle 2a can also be monitored with the aid of the method, in particular if no trailer 2b is coupled on. Furthermore, the method can also be used for monitoring taillights 5 of a one-piece vehicle 1, which only includes the motor vehicle 2a, for example, a van, luggage cart, flatbed truck, et cetera.

To carry out such monitoring, the control unit 6 is connected via a corresponding interface 6a to a bus system 10 of the vehicle 1, for example, a CAN bus, in order to initially be able to establish whether the respective taillight 5 of the vehicle 1 is currently activated or not. A corresponding message or an activation signal S5 having the information about an activation or deactivation of the taillight 5 is transmitted via the bus system 10 here. Monitoring is only reasonable at all if a respective taillight 5 is activated.

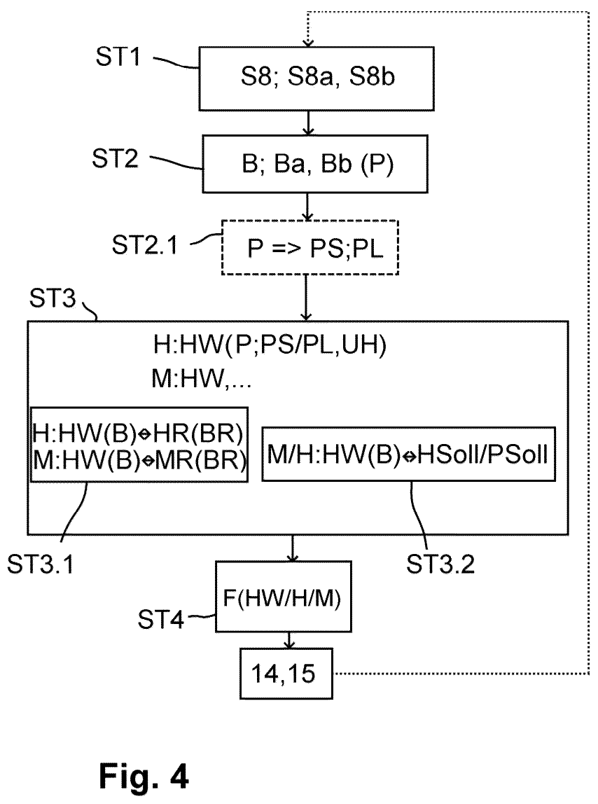

Using a monitoring system 20, which is formed by the control unit 6 and the camera system 4 or the cameras 8; 8a, 8b, the method for monitoring the taillight(s) 5; 5a, 5b of the vehicle 1 can be carried out, for example, in the following steps shown in FIG. 4:
capturing at least one taillight 5; 5a, 5b of the vehicle 1 and/or its light surroundings U5 by way of the camera 8; 8a, 8b on the vehicle 1 and outputting camera signals S8; S8a, S8b (ST1);
providing a camera image B; Ba, Bb having pixels P or image points depending on the output camera signals S8; S8a, S8b, wherein the at least one taillight 5; 5a, 5b of the vehicle 1 and/or the light surroundings U5 is displayed in light pixels PL of the respective camera image B; Ba, Bb (ST2);
ascertaining and evaluating brightness values HW at least for the light pixels PL of the respective camera image B; Ba, Bb (ST3); and
ascertaining and outputting a functional status F of the at least one taillight 5; 5a, 5b depending on the ascertained and evaluated brightness values HW, in particular depending on the brightness values HW which are assigned to the respective displayed taillight 5; 5a, 5b and/or the light surroundings U5 in the respective camera image B; Ba, Bb (ST4).

As indicated by the dotted semicircle (capture area E) in FIG. 1, all taillights 5; 5a, 5b of the two-part vehicle 1 here, but also the light surroundings U5, in which the light of the respective taillight 5; 5a, 5b is incident, can be captured in first step ST1 by the respective camera 8; 8a, 8b having a fisheye lens. The generated camera signals S8; S8a, S8b and/or the camera image B; Ba, Bb formed therefrom in second step ST2 are then conducted to the control unit 6, which then carries out a light/dark recognition in particular for the light pixels PL in the provided camera image B; Ba, Bb on the basis of the brightness values HW ascertained in third step ST3.

In such processing of the respective camera image B; Ba, Bb, it is possible that brightness values HW of pixels P are also ascertained and evaluated which are not assigned or can be clearly assigned to a taillight 5; 5a, 5b or the light surroundings U5, for example, because no clear delimitation of image areas with and without taillight 5; 5a, 5b or with and without irradiated light surroundings U5 is possible or provided. This is to be taken into consideration accordingly in the following observation.

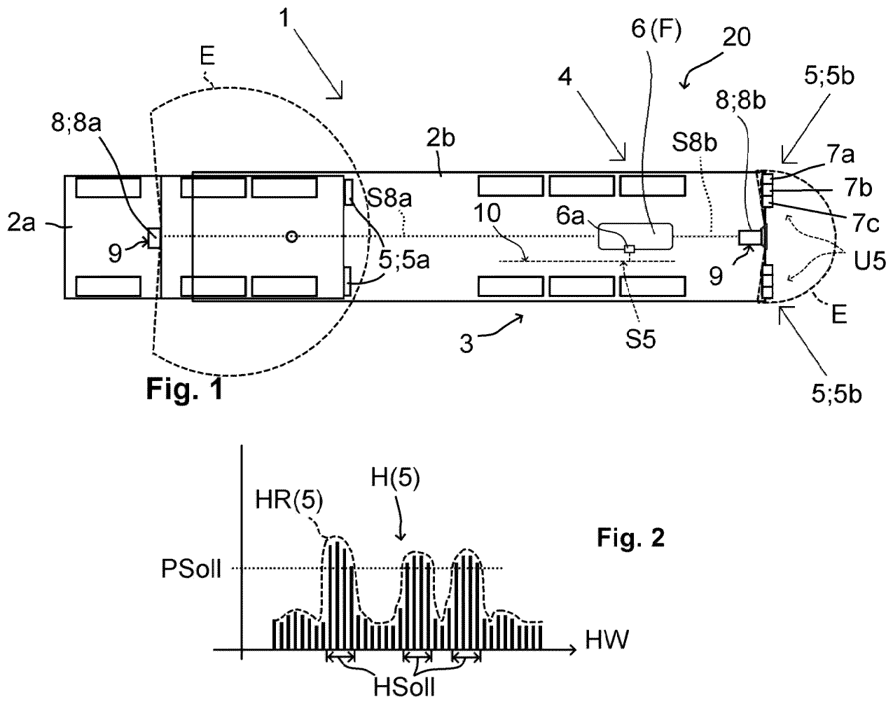

In the light/dark recognition, the ascertained brightness values HW can be subjected, for example, to a histogram comparison in a first evaluation step ST3.1. In the context of the histogram comparison, the distribution of the brightness values HW of the relevant pixels P is represented in a histogram H, as indicated by way of example in FIG. 2. This created histogram H can then be compared to a reference histogram HR (shown by dashed lines in FIG. 2), wherein a distribution of brightness values HW of the relevant pixels P is likewise plotted in the reference histogram HR.

The reference histogram HR follows here from a historic, previously recorded reference camera image BR, in which, for example, fully functional taillights 5; 5a, 5b or in which the light surroundings U5 irradiated thereby are displayed. The histogram comparison thus includes in this embodiment a comparison of historic brightness values HW in the fully functional state of the taillights 5; 5a, 5b with brightness values HW for the current state of the taillights 5; 5a, 5b.

Additionally, it can be provided here that the histogram H is subjected to a brightness adaptation before the comparison to the reference histogram HR, wherein the brightness values HW shown in the histogram H are adapted for this purpose depending on a current ambient brightness UH. It is thus taken into consideration that the ambient brightness UH can vary strongly, for example, depending on the time of day or depending on the surroundings, which also has effects on the histogram H or the brightness values HW depicted therein. In order that this effect can be taken into consideration, the ambient brightness UH is calculated out or the histogram H is scaled accordingly in the brightness in order to provide a histogram H for comparison to the reference histogram HR independently of the ambient brightness UH. The ambient brightness UH can be ascertained, for example, by averaging of the brightness values HW of all pixels P of the camera image B; Ba, Bb or the brightness values HW of all pixels P except for the light pixels PL.

If it then follows from the reference histogram HR that a deviating or higher intensity is present for the fully functional taillights 5; 5a, 5b than from the current histogram H, it can be concluded that the taillight(s) 5; 5a, 5b displayed in the current camera image B; Ba, Bb or the taillight(s) 5; 5a, 5b irradiating the displayed light surroundings U5 is/are defective or covered (dirt or snow). This is because both a defect and also covering cause a change, in particular a reduction, of the respective brightness value HW (in relation to the brightness value to be expected). A corresponding output of the functional status F can thereupon take place in fourth step ST4.

According to a further embodiment, the reference histogram HR, in accordance with the activation signal S5, can also follow from a historic, previously recorded reference camera image BR in a situation having deactivated taillights 5; 5a, 5b and the histogram H can follow after the activation of the taillights 5; 5a, 5b from the camera image B; Ba, Bb which is then current. In this embodiment, the histogram comparison includes a comparison of historic brightness values HW in the deactivated state of the taillights 5; 5a, 5b with brightness values HW for the current state of the taillights 5; 5a, 5b in the activated state This embodiment is then suitable for a direct display of the taillights 5; 5a, 5b in the light pixels PL and also in the case of a display of the light surroundings U5, which is irradiated by the taillights 5; 5a, 5b.

However, a functionality of the taillights 5; 5a, 5b can also be concluded from the histogram H in a further embodiment without making use of a reference histogram HR. For this purpose, it can be established, for example, in a second evaluation step ST3.2 whether the majority of brightness values HW are in one or more desired brightness range(s) HSoll of the histogram H to be expected for the respective displayed or used taillight 5; 5a, 5b, possibly also in consideration of the ambient brightness UH as described above. For this purpose, for example, a desired pixel proportion PSoll (relative or absolute) of pixels P, which are in the desired brightness range(s) HSoll, can be defined. The desired pixel proportion PSoll can be oriented, for example, to the size of the observed image detail (number of pixels P) and/or the resolution of the camera image B; Ba, Bb and/or which type (gravel, asphalt, building, ego vehicle 1, et cetera) of light surroundings U5 is irradiated.

Furthermore, one or more desired brightness range(s) HSoll is/are assigned to each taillight 5; 5a, 5b depending on the type and extent of the light units 7a, 7b, 7c located therein, since, for example, a taillight 5; 5a, 5b which only lights red causes a different distribution of the brightness values HW in the histogram H than a taillight 5; 5a, 5b which only lights orange or only lights white or a taillight 5; 5a, 5b having light units 7a, 7b, 7c that light up in different colors.

The functional status F of the respective taillight 5; 5a, 5b can then be ascertained in fourth step ST4 from whether the desired pixel proportion PSoll for the respective relevant desired brightness range HSoll is reached (or exceeded) or not. If taillights 5; 5a, 5b having light units 7a, 7b, 7c that light up in different colors are located adjacent to one another, multiple desired brightness ranges HSoll can then be subjected to such an evaluation simultaneously (separately for each color) and therefore the functional status F can be ascertained for different light units 7a, 7b, 7c in parallel to one another.

A light monitoring function can therefore also be carried out via the camera system 4, which is already present in the vehicle 1 as a component of the reversing assistant 3, by a corresponding expansion in the signal evaluation in the control unit 6.

According to a further embodiment, it can be provided that, for the evaluation of the brightness values HW, a feature representation M is used instead of a histogram H, in which not only the brightness is observed as a dimension, but also, for example, a color channel (RGB), a saturation, contrast, et cetera. Therefore, a feature representation M in a higher-dimensional feature space is used, which enables a more detailed evaluation. The light monitoring can then be carried out in a comparable manner as for the histogram H by a comparison of the feature representation M with a reference feature representation MR, for example, by the tools of machine learning. The reference feature representation MR is generated here for the respective additional features of the feature space under the same conditions as described for the reference histogram.

In addition, in a calibration step ST2.1, the position of the light pixels PL in the camera image B; Ba, Bb can be calibrated beforehand which further improves the reliability of the method or makes the recognition more stable, since primarily brightness values HW or features of the light pixels PL in the camera image B; Ba, Bb or in the reference camera image BR can be used for the creation of the histogram H or the feature representation M and possibly the reference histogram HR or the reference feature representation MR.

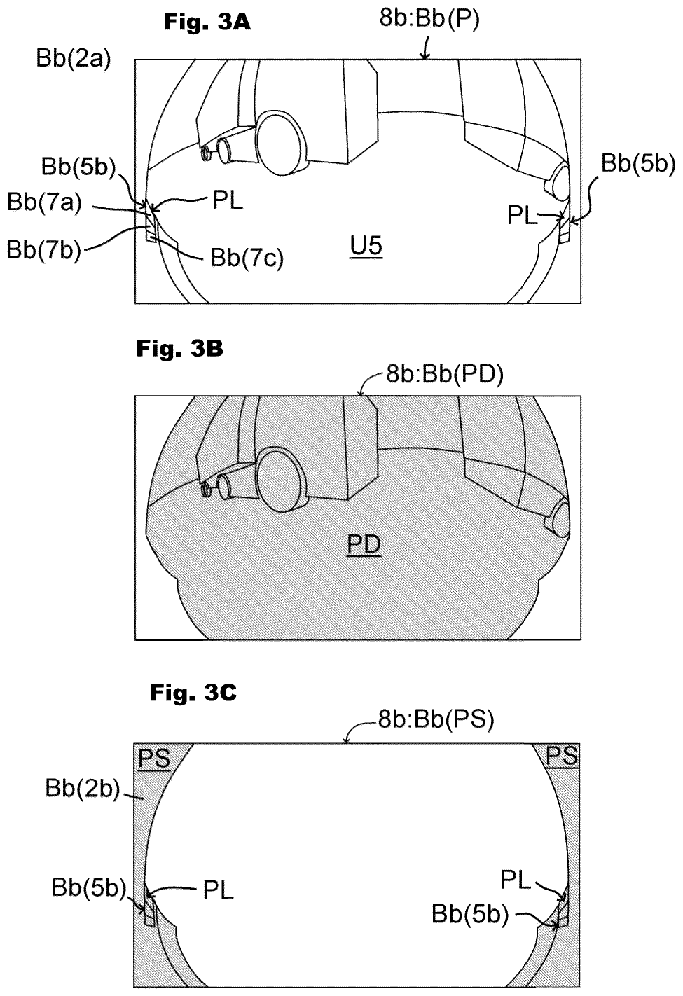

For this purpose, FIG. 3A shows a black-and-white camera image Bb recorded by the trailer camera 8b, which consists of multiple pixels P. This camera image Bb of the trailer camera 8b also shows the fixed position of the trailer taillights 5b or the light pixels PL assigned thereto. The position of the light pixels PL does not change, since both the trailer camera 8b and also the trailer taillights 5b are fixedly connected to the vehicle 1 or the trailer 2b and therefore their relative position in relation to one another is fixed.

This can be utilized for calibrating the position of the light pixels PL. For this purpose, the camera image Bb of the trailer camera 8b, as shown in FIGS. 3B and 3C, is divided into areas having dynamic pixels PD (FIG. 3B, shaded) and areas having static pixels PS (FIG. 3C, shaded). It is presumed here that the dynamic pixels PD will change due to the changing surroundings during a journey of the vehicle 1, while the trailer 2b is displayed uniformly in the static pixels PS. Accordingly, the trailer taillights 5b or the light pixels PL assigned thereto fall into the area of the static pixels PS as a subset, wherein the static pixels PS can be recognized by corresponding image processing.

The number of pixels P which are used from the camera image Bb of the trailer 2b to create the histogram H or the feature representation M can thus already be significantly reduced if only the static pixels PS are used. This also applies for the creation of the reference histogram HR or the reference feature representation MR in the first evaluation step ST3.1, wherein only the static pixels PS in the reference camera image BR are also used for this purpose.

This can be refined still further in that, for example, during the initial installation, histograms H or feature representations M are created for these static pixels PS during an activation and a following deactivation of the trailer taillights 5b and these are evaluated over time. It can be ascertained beforehand for each individual static pixel PS from a change of the brightness values HW or the features during such an initial activation/deactivation whether or not it is assigned to a trailer taillight 5b or whether or not this static pixel PS is a light pixel PL. This finding can then be used for the following monitoring of the trailer taillights 5b in that only the already identified light pixels PL are still used to create the current histogram H or the current feature representation M. The histogram H or the feature representation M which is created after the initial activation of the trailer taillights 5b can then also be stored simultaneously as a reference histogram HR or reference feature representation MR.

If such a refined selection of static pixels PS cannot be made, a type of “background” (components in addition to the taillights 5; 5a, 5b) is at least to be taken into consideration in the evaluation of the histogram H or the feature representation M in the second evaluation step ST3.2, which results in a corresponding modified distribution of the brightness values HW or features. In first evaluation step ST3.1, in contrast, this background is also still to be found in the reference histogram HR or in the reference feature representation MR, so that it is already taken into consideration in the histogram comparison or feature representation comparison.

If the respective camera 8; 8a, 8b is furthermore configured such that it can only reliably capture the light surroundings U5, that is, the surroundings irradiated by the respective taillight 5; 5a, 5b or light unit 7a, 7b, 7c, and cannot capture or cannot completely capture the respective taillight 5; 5a, 5b or light unit 7a, 7b, 7c, such a refined selection of static pixels PS can also only be made to a limited extent. In this case, the above-described histogram comparison or feature representation comparison between activated and deactivated taillights 5; 5a, 5b or light units 7a, 7b, 7c or the evaluation of the desired pixel proportions PSoll for the respective relevant desired brightness range HSoll is to be used.

The described selection of pixels P by division into static and dynamic pixels PS, PD is moreover also carried out for the motor vehicle taillight 5a or each further taillight 5 on the vehicle 1 in an identical manner.

Depending on the ascertained functional status F, for example, a heating element 14 can then be switched on situationally, which deliberately heats the respective taillight 5; 5a, 5b or light unit 7a, 7b, 7c, for example, to thaw off covering snow, which can result in reduced brightness values HW. The heating element 14 can thus only be used in an energy-saving manner if probable covering with snow is concluded on the basis of the functional status F. A cleaning system 15 can also be deliberately actuated in order, for example, to clean soiled taillights 5; 5a, 5b, which can also result in reduced brightness values HW.

After such an actuation of the heating element 14 and/or the cleaning system 15, the monitoring can then be carried out again in the described steps. If the brightness values HW still indicate a defective or covered taillight 5; 5a, 5b even then, this can ultimately be output as the functional status F, to which the driver can react accordingly.

It is understood that the foregoing description is that of the preferred embodiments of the invention and that various changes and modifications may be made thereto without departing from the spirit and scope of the invention as defined in the appended claims.

### List of Reference Signs (Part of the Description)

1 vehicle
2a motor vehicle
2b trailer
3 reversing assistant
4 camera system
5a taillights of the motor vehicle 2a
5b taillights of the trailer 2b
6 control unit
6a interface
7a, 7b, 7c light unit
8 camera
8a motor vehicle camera
8b trailer camera
9 fisheye camera
10 bus system
14 heating element
15 cleaning system
20 monitoring system
B camera image of the camera 8
Ba camera image of the motor vehicle camera 8a
Bb camera image of the trailer camera 8b
BR reference camera image
E capture area
F functional status
H histogram
HR reference histogram
HW brightness value
HU ambient brightness
M feature representation
MR reference feature representation
P pixels
PL light pixels
S5 activation signal
S8 camera signal of the camera 8
S8a camera signal of the motor vehicle camera 8a
S8b camera signal of the trailer camera 8b
U5 light surroundings

1. A method for monitoring a taillight of a vehicle via a camera system, wherein the camera system includes a camera directed to the rear, wherein the taillight includes a light unit, the method comprising:
capturing, via the camera, at least one of the taillight of the vehicle and light surroundings illuminated by the taillight and outputting camera signals;
providing a camera image having pixels depending on the output camera signals, wherein the at least one of the taillight of the vehicle and the light surroundings illuminated by the taillight is displayed in light pixels of the camera image;
ascertaining and evaluating brightness values for the light pixels of the camera image; and,
ascertaining and outputting a functional status of the taillight depending on the ascertained brightness values.

2. The method of claim 1, wherein said ascertaining the functional status of the taillight includes creating at least one of a histogram and a pattern representation from the provided camera image, wherein a distribution of the brightness values at least of the light pixels of the camera image is represented in the at least one of the histogram and the pattern representation.

3. The method of claim 2 wherein said ascertaining the functional status of the taillight includes providing a reference camera image; and, wherein at least one of:
the histogram created from the provided camera image is compared with a reference histogram, wherein the reference histogram is created from the reference camera image; and,
the pattern representation created from the camera image is compared with a reference pattern representation, wherein the reference pattern representation is created from the reference camera image.

4. The method of claim 3, wherein:
in the reference camera image the taillight of the vehicle is represented in a fully functional state and the light surroundings are shown in a state irradiated by the taillight of the vehicle in the fully functional state;
wherein the functional status of the taillight is ascertained and output as defective or covered if at least one of:
the histogram created from the camera image deviates from the reference histogram; and,
the pattern representation created from the camera image deviates from the reference pattern representation.

5. The method of claim 3, wherein, in the reference camera image, at least one of the taillight is represented in a deactivated state and the light surroundings are shown in a state in which the taillights of the vehicle is in the deactivated state,
wherein the functional status of the taillight is ascertained and output as defective or covered if at least one of:
the histogram created from the camera image corresponds to the reference histogram; and,
the pattern representation created from the camera image corresponds to the reference pattern representation.

6. The method of claim 3, wherein at least one of:
the histogram, before the comparison with the reference histogram, is subjected to a brightness adaptation, wherein the brightness values represented in the histogram are adapted for the brightness adaptation depending on a current ambient brightness; and,
the pattern representation, before the comparison with the reference pattern representation, is subjected to a brightness adaptation, wherein the brightness values represented in the pattern representation are adapted for the brightness adaption depending on the current ambient brightness.

7. The method of claim 2, wherein said ascertaining the functional status of the taillight includes ascertaining whether the brightness values of at least one of the histogram and the pattern representation lie in at least one desired brightness range assigned to the taillight.

8. The method of claim 7 further comprising ascertaining whether at least one defined desired pixel proportion of brightness values lies in the at least one desired brightness range assigned to the taillight.

9. The method of claim 8, wherein the functional status of the taillight is ascertained and output as defective or covered if the brightness values of at least one of the histogram created from the camera image and the pattern representation created from the camera image do not lie within the at least one assigned desired brightness range or do not lie in the defined desired pixel proportion within the at least one assigned desired brightness range.

10. The method of claim 7, wherein the at least one desired brightness range is assigned to each light unit of the taillight.

11. The method of claim 1, wherein said ascertaining and evaluating the brightness values is only carried out for static pixels of the provided camera image; and, the light pixels are contained in the static pixels.

12. The method of claim 11, wherein the static pixels of the provided camera image are identified beforehand in a calibration step during a journey of the vehicle.

13. The method of claim 1, wherein said ascertaining and evaluating the brightness values is only carried out for the light pixels of the provided camera image; the light pixels are identified in that the brightness values of the pixels of the provided camera image are evaluated over time during an activation and a subsequent deactivation of the taillight; wherein the pixels, the brightness values of which change over time due to the activation and subsequent deactivation of the taillight, are identified as the light pixels.

14. The method of claim 1, wherein the monitoring of the taillight is carried out for at least one of a motor vehicle taillight on a motor vehicle of the vehicle and a trailer taillight on a trailer of the vehicle; wherein the taillight includes a light unit selected from a group including a reflector, a brake light, a rear light, a rear fog light, a license plate lamp, a turn signal, and an outline light.

15. The method of claim 1, wherein at least one of a heating element on the taillight and a cleaning system of the taillight is actuated depending on at least one of:
the ascertained and evaluated brightness values at least for the light pixels of the camera image; and,
the ascertained and output functional status of the taillight.

16. The method of claim 15, wherein the method is repeated after a completed actuation of at least one of the heating element and the cleaning system.

17. The method of claim 1 further comprising checking whether the taillight is activated before said ascertaining and outputting the functional status of the taillight depending on the ascertained brightness values.

18. A monitoring system for a vehicle, the monitoring system comprising:
a camera system having a camera directed to the rear for capturing at least one of a taillight of the vehicle and light surroundings illuminated by the taillight, wherein the camera is configured to output camera signals;
a control unit configured to:
process a camera image provided depending on the output camera signals, the camera image having pixels, wherein at least one of the taillight of the vehicle and the light surroundings illuminated by the taillight is represented or depicted in light pixels of the camera image;
ascertain and output brightness values at least for the light pixels of the camera image; and,
ascertain and output a functional status of the taillight depending on the ascertained brightness values.

19. The monitoring system of claim 18, wherein said camera directed to the rear has a capture area such that the at least one of the taillight and the light surroundings is directly capturable by said camera or that only the light surroundings can be captured.

20. The monitoring system of claim 19, wherein the camera is a fisheye camera.

21. The monitoring system of claim 18, wherein said camera system is part of a reversing assistant.

22. The monitoring system of claim 18, wherein said control unit includes an interface for picking up an activation signal; the activation signal transmits whether the taillight is activated or not; and, said control unit is configured to establish, before the ascertainment of the functional status of the taillight, whether the taillight is activated on a basis of the activation signal.

23. A vehicle comprising:
a monitoring system including a camera system having a camera directed to the rear for capturing at least one of a taillight of the vehicle and light surroundings illuminated by the taillight, wherein the camera is configured to output camera signals;
said monitoring system further including a control unit configured to:
process a camera image provided depending on the output camera signals, the camera image having pixels, wherein at least one of the taillight of the vehicle and the light surroundings illuminated by the taillight is represented or depicted in light pixels of the camera image;
ascertain and output brightness values at least for the light pixels of the camera image; and,
ascertain and output a functional status of the taillight depending on the ascertained brightness values; and,
wherein said camera is at least one of a motor vehicle camera on the motor vehicle of the vehicle and a trailer camera on a trailer of the vehicle, which are each oriented to the rear.

24. The vehicle of claim 23, wherein the vehicle is a utility vehicle.
